(19) United States
(12) Patent Application Publication
(10) Pub. No.: US 2018/0132183 A1
(43) Pub. Date: May 10, 2018

(54) WIRELESS DEVICE POWER SAVING SYSTEM AND METHOD

(71) Applicant: CARRIER CORPORATION, Jupiter, FL (US)

(72) Inventor: Ramakrishna Gattu, Suryapet (IN)

(21) Appl. No.: 15/669,306

(22) Filed: Aug. 4, 2017

(30) Foreign Application Priority Data
Nov. 4, 2016 (IN) 201611037683

(51) Int. Cl. H04W 52/02; H04W 4/00; G05B 15/02

(52) U.S. Cl. CPC H04W 52/0235; H04W 52/0203; H04W 84/20; G05B 15/02; H04W 4/008

(57) ABSTRACT

A system and method for managing power consumption in a wireless network, including an HVAC system with a wireless network. The method and system include, a first wireless device configured as a master, the master operates in one of a central role and observer role and a second wireless device configured as a slave, wherein a slave operates in one of a first role and a second role, the first wireless device and the second wireless device exchange data over the wireless network. The method and system also include that the second wireless device is configured to operate in the other of the first role and the second role under a selected condition.

### CROSS-REFERENCE TO RELATED APPLICATIONS

This application claims the benefit of India Application No. 201611037683 filed Nov. 4, 2016, which is incorporated herein by reference in its entirety.

### BACKGROUND OF THE DISCLOSURE

This disclosure relates in general to a wireless control system and a wireless network power saving method applied thereto. More particularly, this disclosure relates to a system and its corresponding method in which Bluetooth Low Energy (BLE) wireless transmission is performed and BLE slave devices are configured to be capable of switching between two slave modes of operation so that the device power consumption is reduced.

Mobile computing devices and controls employing wireless communications have become pervasive in people's everyday life. There are a large variety of products, such as information, communication, and entertainment products, employing wireless transmission. Examples of the products employing wireless transmission comprise notebook computer, keyboard, mouse, fax machines, projectors, printers, scanners, digital cameras, mobile phones, personal digital assistant, tablet PC, network cameras, TVs, stereos, speakers, headphones, microphones and modems.

In terms of current technologies, a variety of technologies have been adopted for wireless communications. For example, microwave, radio frequency (RF), laser, Wi-Fi®, third generation cellular (3G), infrared (IR), Bluetooth®, ZigBee® can be used in related wireless devices according to actual needs. Different wireless technologies are more effective at different applications. Most employ different transmission specifications or protocols have respective transmission frequency bands, transmission rates, transmission range, power consumptions requirement and can be used according to the needs of application. For example, Bluetooth® is a wireless signal transmission technology that can achieve wireless signal transmission within a short distance (dozens of meters) with moderated data transmission rates using a frequency band of 2.45 GHz. Bluetooth technology, advantageously featured by lower power consumption, small chip size and low cost, is well suited for connecting related wireless devices within a particular range and can be used in the control of wireless signal transmission within a short distance.

Different transmission specifications or protocols have different features and are subjected to different transmission restrictions or disadvantages. With, Bluetooth wireless transmission for example, although the transmission distance, data rate and power consumptions is suitable, for many short range purposes, the number of devices connected is limited and the power consumption for some applications may still be too high for some desired applications, particularly battery operated applications. Bluetooth® Low Energy (BLE) improves on the power consumption and expands applicability, but still may not be suitable for some applications. For example, for battery powered wireless sensors, communications from a sensor of data to a controller may consume too much power resulting in a need for frequent battery replacements or larger capacity batteries. Frequent replacement of batteries or recharging is an inconvenience to the user. Larger capacity batteries may not be practical for many wireless applications. What would be beneficial would be a means to conserve power consumption in wireless communication technologies in particular for wireless sensors and devices employing Bluetooth wireless communications.

### BRIEF SUMMARY

According to one embodiment, described herein is a method of managing power consumption in a wireless network. The method includes configuring a first wireless device as a master, wherein the master operates in one of a central role and an observer role; configuring a second wireless device as a slave, wherein the slave operates in one of a first role and a second role, wherein the first wireless device and the second wireless device exchange data over the wireless network; and changing the second wireless device to operate in the other of the first role and the second role under selected conditions independent of the power supplied to the second wireless device.

In addition to one or more of the features described above, or as an alternative, further embodiments may include that the first role is a broadcaster role and the second role is a peripheral role.

In addition to one or more of the features described above, or as an alternative, further embodiments may include that the changing is based on a time division or time interval. Moreover, in addition, that the time division includes operating in the first role for a first selected duration and operating in the second role for a second selected duration.

In addition to one or more of the features described above, or as an alternative, further embodiments may include that the changing is based on at least one of a user input, application of an external power supply, a command from the first wireless device, selected types of data to be transmitted from the second wireless device, an important data exchange and a heartbeat function.

In addition to one or more of the features described above, or as an alternative, further embodiments may include that the first wireless device and the second wireless device are Bluetooth Low Energy devices.

Also described herein in an embodiment is a system for managing power consumption in a wireless network. The system includes a first wireless device configured as a master, wherein the master operates in one of a central role and an observer role; a second wireless device configured as a slave, wherein the slave operates in one of a first role and a second role, wherein the first wireless device and the second wireless device exchange data over the wireless network; and wherein the second wireless device is configured to operate in the other of the first role and the second role under a selected condition independent of the power supplied to the second wireless device.

Also described herein in an embodiment is a heating, ventilation and air conditioning (HVAC) management system configured to control an atmospheric condition of a space. The HVAC management system comprising a plurality of air manipulation components to alter the atmospheric condition of the space; a controller in operative communication with the plurality of air manipulation components, the controller comprising a first wireless device configured as a master for receiving at least one parameter from a sensor via a wireless network and operating in one of a central role and observer role; and a sensor disposed proximate to the space for sensing a parameter associated with the space; the sensor operable as a second wireless device configured as a slave operable in one of a first role and a second role, and wherein the sensor is configured to operate in the other of the first role and the second role under a selected condition.

In addition to one or more of the features described above, or as an alternative, further embodiments may include that the first wireless device and the second wireless device are Bluetooth Low Energy devices.

In addition to one or more of the features described above, or as an alternative, further embodiments may include that the first role is a broadcaster role and the second role is a peripheral role.

In addition to one or more of the features described above, or as an alternative, further embodiments may include that the selected condition is based on at least one of: a time division, a user input; application of an external power supply; a command from the first wireless device; selected types of data to be transmitted from the second wireless device; and a heartbeat function.

Technical effects of embodiments of the present disclosure include managing power consumption in a wireless network, configuring a first wireless device as a master, configuring a second wireless device as a slave, wherein the first wireless device and the second wireless device exchange data over the wireless network; and changing the second wireless device to operate in the other of the first role and the second role.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosed embodiments are apparent from the following detailed description taken in conjunction with the accompanying drawings. The drawings that accompany the detailed description can be briefly described as follows:

FIG. 1 is a schematic illustration of a wireless network and controls system in accordance with an embodiment;

FIG. 2 is a schematic illustration of a wireless network and controls system depicting a change in role in accordance with an embodiment;

FIG. 3 depicts further detail associated with a change in role in accordance with an embodiment; and

FIG. 4 is a flowchart depicting a method of conserving power in a wireless network in accordance with an embodiment.

### DETAILED DESCRIPTION OF THE DISCLOSURE

The following description is merely illustrative in nature and is not intended to limit the present disclosure, its application or uses. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

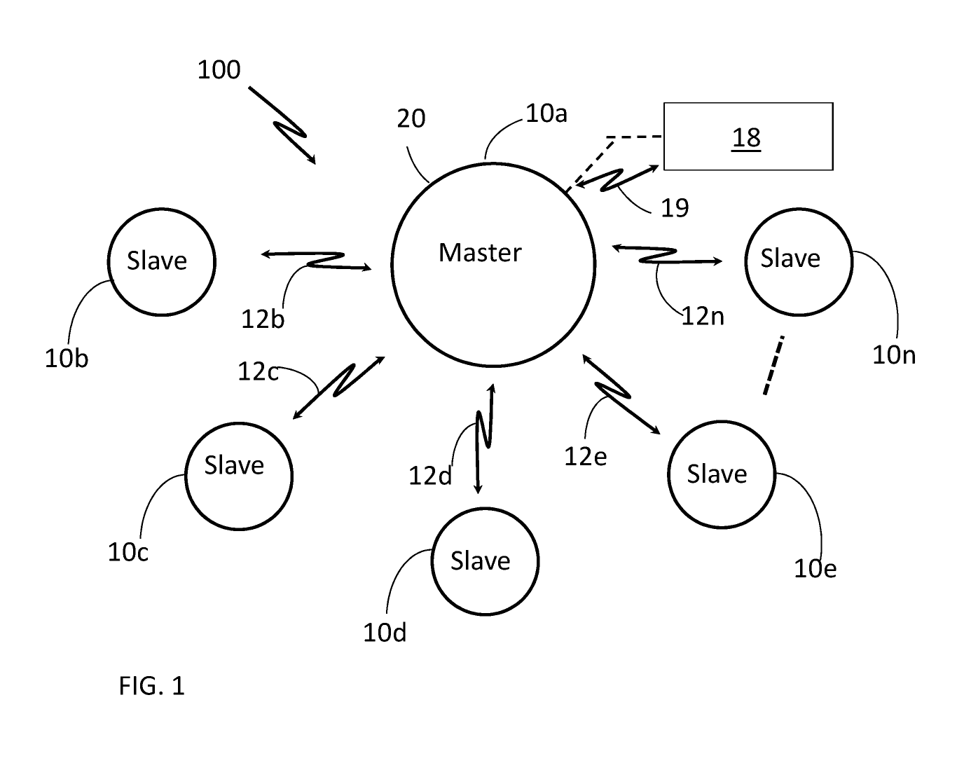

The wireless control system and the wireless network power conservation method applied thereto provided in the present disclosure are exemplified by the embodiments below. Referring to FIG. 1, a diagram depicting a control system employing a wireless network 100 using a wireless network power conservation method are shown. The control system 100 includes a plurality of wireless devices 10a-10n with one also identified as controller 20. In an embodiment, controller 20 controls operations of the wireless devices 10a-10n. Furthermore, wireless communication may be performed between the controller 20 and each of the wireless devices 10b-10n or between the wireless devices 10b-10n via a wireless signal 12b-12n. In addition the wireless signal 12b-12n can also be broadcast and received by other wireless devices 10a-10n. The wireless communication employed by the control system 100 of the disclosed embodiments can be regarded as a Bluetooth network or system, and both the controller 20 and each of the wireless devices 10a-10n can be regarded as a Bluetooth device, in particular for an embodiment a Bluetooth Low Energy (BLE) device. The communications between BLE devices 10a-10n is dictated by a known established communications protocol.

BLE devices 10a-10n operating per the communication protocol can serve four different roles, namely a central role, an observer role, a peripheral role and a broadcaster (beacon) role, according to the practical needs of the application. In general, the BLE device 10a-10n serving the central role is used for locating BLE devices 10a-10n serving the peripheral role, creating Bluetooth connection and performing wireless transmission. The BLE device 10a-10n serving the peripheral role can be located by a BLE device 10a-10n serving the central role and connected thereto for transmitting data. BLE 10a-10n serving the broadcaster role can broadcast data and information only. BLE devices 10a-10n serving the observer role can observe the data correspondingly broadcasted by a BLE device 10a-10n operating in a broadcaster role.

In an embodiment, BLE devices 10a-10n can operate in two modes, the first is commonly referred to as master and the second is commonly referred to as slave. The first role, performed by the master, refers to the central role and observer role, while the second role, typically performed by the slave, refers to a peripheral and broadcaster role. A BLE device 10a-10n serving the first role as master observes and receives a control command broadcasted by other wireless devices. While a BLE device 10a-10n serving the second role broadcasts a received control command to other wireless BLE devices 10a-10n. In an embodiment as depicted in FIG. 1, BLE device 10a is configured as a master and also as controller 20, while BLE devices 10b-10n are configured to operate as a slave.

A BLE device 10a-10n operating in a broadcaster role is a transmitter only, with such BLE devices 10a-10n using what is known as advertising packets to broadcast data and information. The broadcaster role does not support connections. In the broadcaster role, there is no configuration or updates required or permitted, nor is there any acknowledgement from a master. Therefore, in the broadcaster role, a slave does not know if a master successfully received the broadcast information. In addition communication security provisions are minimal. BLE protocol does not provide any security to advertising or broadcast packets. There is no link layer encryption on broadcast packets, there is no encryption or security associated with payload of the broadcast packet which contains the transmitter's information or data to be reported to the BLE device 10a-10n operating in master/observer role. Advantageously however, because of its simplicity, the broadcast mode is a low-power mode configuration since it does not have the overhead of a connection procedure and maintaining a connection.

The other role a BLE device 10a-10n operating as a slave can have is that of a peripheral. The peripheral role is connection oriented. In the peripheral role, BLE protocol provides security in terms of authentication and encryption, BLE devices 10a-10n operating in a central role and peripheral role authenticate and exchange security keys for encryption, thus connection can be authenticated and communication can be encrypted in link layer. BLE device 10a-10n operating in a peripheral role can have bi-directional communication and can be configured to receive data from a BLE device 10a-10n configured as a master. This can be very useful when BLE devices 10a-10n configured as slave devices need configuration or bi-directional data exchange or additional features such as software upgrade over the air. A BLE device 10a-10n configured as a peripheral generally communicates on Generic Attributes (GATT) layer and may employ all GATT layer capabilities. GATT is the top most data layer of the BLE protocol, GATT is a client/server protocol model to allow read, write and push data elements between BLE devices.

Connection procedures defined by the Bluetooth protocol are employed to exchange connection information and security parameters between a BLE devices 10a-10n configured as a master and one configured as a slave. As should be appreciated, such communication between a master and slave is logically more power consuming. When operating as a peripheral device connection is maintained between master and slave by transmission and reception of connection packets in a periodic interval (connection interval). Unfortunately, this communication scheme inherently includes additional overhead to communicate information and consumes power, even when there is no data to communicate. Typically a BLE device 10a-10n operating in a peripheral role consumes about much more power than BLE device 10a-10n operating in a broadcast role. Some systems have been implemented to permit changing roles between BLE devices 10a-10n. Some permit configuration between master, observer role and a slave role. Some have included configuration between a connectable and non-connectable role, i.e., a slave configuration operating in a peripheral or broadcast role if there is sufficient operating power to operate in a connectable role. Described herein in the embodiments are schemes for changing the role of a slave unit based on a variety of parameters independent of the sufficiency of applied power.

In addition, in most systems, the number of connections between BLE devices 10a-10n in BLE system is limited. Typically, only about seven BLE devices 10a-10n in a operating in a peripheral role can be connected to BLE devices 10a-10n operating as a central device role at a time. Advantageously, the described embodiments improve on this limitation by selectively placing BLE devices 10a-10n in a peripheral role. So for example, in the embodiments described, one or a few BLE devices 10a-10n devices configured as slaves operating in a peripheral role connect to the BLE devices 10a-10n configured as master operating in a central role. While other BLE devices 10a-10n are operating in a broadcasting role. The BLE devices 10a-10n may then take turns to connect and exchange data while other devices continue broadcasting.

Continuing with FIG. 1 the various embodiments may be described in the context of different systems that may employ BLE devices. A heating, ventilation and air conditioning (HVAC) management system employing the wireless system is also schematically illustrated and generally referenced with numeral 100. The HVAC management system 100 is employed to adjust at least one atmospheric condition within a space not shown, e.g., a building. In the illustrated embodiment, the space is a single room of a building, but it is to be appreciated that the space may comprise multiple rooms in any conceivable arrangement. This includes residential dwellings, office buildings, factories, etc. These are merely illustrative examples and are not limiting of the type of structures within which the space may be present.

The at least one atmospheric condition referenced above relates to the control and regulation of temperature and/or humidity, for example. In the context of temperature, the number of occupants of the space impacts the air and energy requirements of the HVAC management system 100. In other words, as more occupants are present in the space, more energy is required to cool the space based on body heat emitted by human beings. Conversely, the energy requirement decreases as the number of occupants is lessened during a cooling operation of the HVAC management system 100. The atmospheric condition control is physically facilitated by operation of a plurality of air manipulation components 18 that move and condition air. The air manipulation components 18 communicate with the controller 20 as needed and depicted by line 19. This communication can be hard wired, or in an embodiment is wireless. In an embodiment the air manipulation components 18 could also be BLE devices. These components include fans, fan coils, furnaces, valves, condensors, heatpumps, heat exchangers, and the like, for example.

Sensors 10b-10n may also include additional occupancy detection components for detecting the number of occupants located within the space. For example, the components may detect occupants based on light sensing, carbon dioxide level sensing, vibration sensing, indoor air quality sensing, toxic gas sensing, and/or smoke sensing. These are merely illustrative examples of the types of additional detection components and are not limiting.

In the example of a Heating, Ventilation, and Air Conditioning (HVAC) system a thermostat is configured as a controller 20 and is connected to multiple sensors 10b-10n, in this instance, wireless BLE devices 10b-10n. Sensors 10b-10n may sense and report environmental and operational parameters (like humidity, temperature, occupancy, air quality etc.) to the thermostat/controller 20. In the examples herein, the controller 20 is a BLE device, here 10a, configured to operate as a master. Likewise various sensors as may be employed in a system are BLE devices 10b-10n, each, in the examples operating as slaves. In the exemplary embodiments herein disclosed are methods and system configurations under which a BLE devices 10b-10n operating as a slave is configured to operate or change is an operation role between a broadcast role and peripheral role. It should be appreciated that while for the purposes of illustration, the controller 20 is described to operate as the master and the various sensor are described to operate as slaves, this configuration is not limiting. Other configurations are possible. Further, for the sake of simplicity, the master function will be described referred to as performed by controller 20 while the function of slave BLE devices 10b-10n, will be referred to as sensors.

In another example application, a security system or fire detection system may employ a control panel as controller 20 and be interconnected with various sensors, including door switches, occupancy detectors motion detectors and the like to implement the functions of a system. Once again, the various security sensors 10b-10n may be BLE devices communicating information to the control panel operating as controller 20.

While the embodiments described herein are made in the context of a HVAC system, it should be appreciated that the examples are for illustration only and should not be considered limiting. The embodiments disclosed are applicable to any system that employs Bluetooth devices, particularly those that are configured to operate primarily as slave devices in broadcast role, but may have instances where operation as a peripheral would be advantageous.

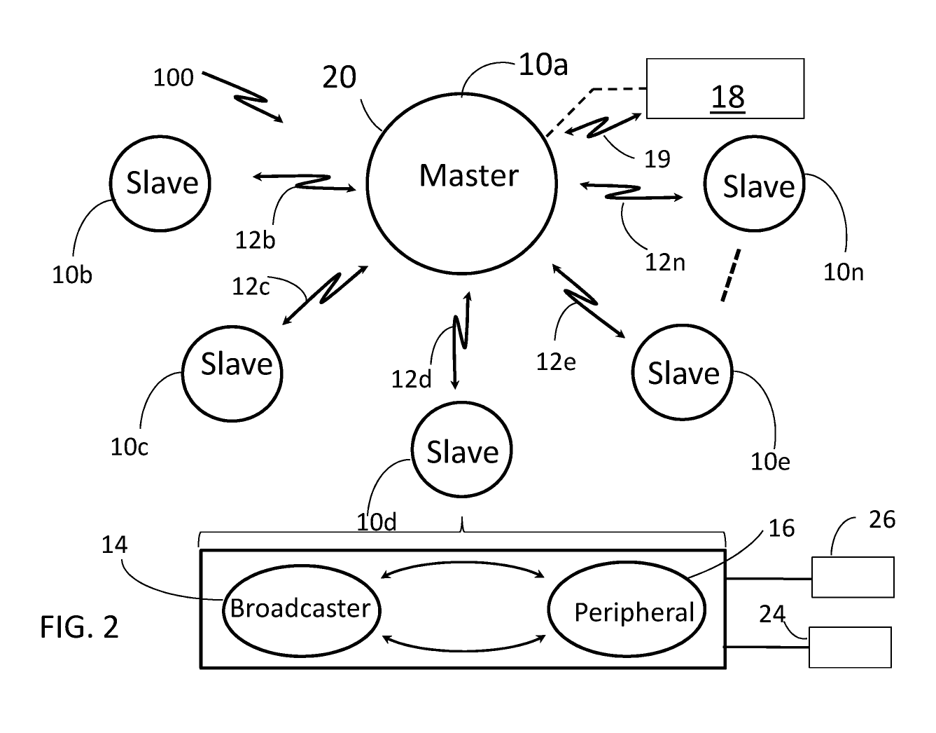

Turning to FIG. 2 as well, a method is also described for a combination of roles of for a BLE device functioning as a slave such as sensors 10b-10n. In an embodiment a sensor 10b-10n that is operating is selectively configured to operate in either broadcast role as depicted by reference numeral 14 or a peripheral role as depicted by reference numeral 16. Advantageously this permits the BLE device 10b-10n operating as a slave to achieve best features of both roles, i.e., lower power consumption when needed to enhance battery life and higher communication reliability and security when desired to ensure communications are accurate and secure.

Turning now to FIG. 2, in an embodiment, the switch of roles for the sensors 10b-10n may be based on one or more of the following conditions: a standard time division or interval; a user triggered event (for example, a button press); on application of some form of external power supply or input; on command from controller 20 (BLE device 10a) operating as a master; for instances of critical/important data exchange, e.g., for predetermined or selected types of data; based on some form of supervisory input of or heartbeat.

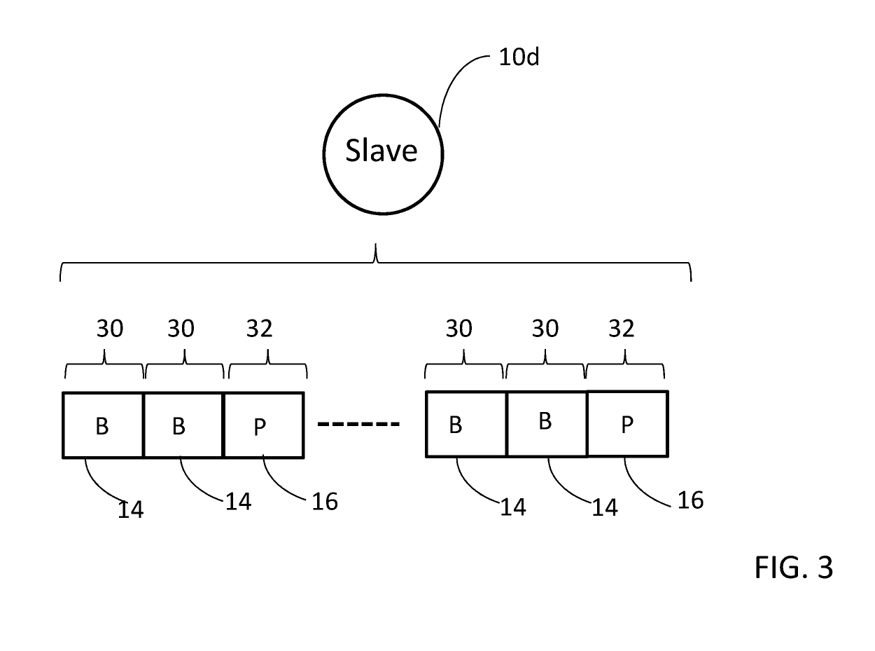

For the time division switching of role functions the sensor 10b-10n (10d shown only for simplicity) may be configured to provide data in a broadcast role 14 for a selected duration and then automatically switch to a peripheral role 16. For example, a sensor 10b-10n that is configured as a slave continuously samples data, for example, environmental parameters. At a selected time interval, e.g., ‘t1’ seconds as depicted by reference numeral 30 (FIG. 3), the sensor 10b-10n can send information as a part of what is termed an “advertisement” packet operating in the broadcaster role 14 to inform the controller 20, (operating as a master) of the sensed environmental parameters. The sensor 10b-10n while sending such a packet configures the packet as a non-connectable-advertisement pursuant to the Bluetooth protocol so that no master attempts to initiate a connection with the broadcasting sensor. This form of broadcast communication requires little power, and is most efficient.

Under some circumstances the sensor 10b-10n may have additional data to share that is of perhaps more important, where in this instance assurance that the controller 20 actually receive the data would be beneficial. In this instance the sensor 10b-10n would want a connection with the master and be operating in the peripheral role 16, To accommodate this communication scheme, in an embodiment, for a second selected time interval ‘t2’ seconds as depicted by reference numeral 32 (FIG. 3), where t₂ is typically greater than t₁, the sensor 10b-10n sends a connectable advertisement to the controller 20 (master), establishes connection to change the sensor 10b-10n to a peripheral role 16. Once the sensor 10b-10n is in the peripheral role 16, it can then transfer additional data. In the HVAC system example, the environmental data, status and health parameters to the controller 20 acting as master. Moreover, the sensor 10b-10n then receives acknowledgement from controller 20 and when t2 lapses, disconnects from the controller 20 and the sensor 10b-10n returns to the broadcaster role 14. There are some unique advantages to the use of this connection period. First, by switching to a peripheral role 16 for a short duration, a sensor 10b-10n can ensure that the controller 20 (master) is receiving the data. Second, controller 20 operating as a master has the opportunity to configure parameters of the sensor 10b-10n, for example sampling interval, reporting interval, and the like. Likewise, operating the sensor 10b-10n in a peripheral role 16 also helps managing sensors. For example, in a commissioning process, where a sensor 10b-10n might include services, characteristics, diagnostics and the like which can be configured by a commissioning or diagnostics device, which may not be possible when operating in a broadcaster only role 14.

Continuing with FIG. 2, in an embodiment, another instance in which a sensor 10b-10n operating in a slave capacity could change functionality would be on a user initiated event. For example, a button press. In an embodiment a sensor 10b-10n may include a user button 24 or some other user interface to change the role of the device. For example, in operation, a sensor 10b-10n is programmed to be configured to be in broadcast role 14 and broadcasts data, for example, environmental sensing data every 60 seconds. If, for example, a user determined that they would prefer to have the data transmitted every 30 seconds, a user presses the button 24 causing the sensor 10b-10n to change its operational role to peripheral 16 and thus is now capable of being configured.

In an embodiment, another instance in which a sensor 10b-10n operating in a slave capacity could change functionality would be on command from a BLE device operating as a master, such as controller 20. In this instance, once again, a sensor 10b-10n is configured to operate in a broadcaster role 14. At a predetermined instance, the sensor 10b-10n may be configured to change operating modes and for a selected duration operate as an observer role. In this instance, for a short duration of time, e.g. sufficient to receive a command, the sensor 10b-10n will turn on its receiver to receive external commands as depicted by communication 12b-12n (12d in this instance) typically from controller 20 (master). However it could also be from another device e.g., another sensor 10b-10n, operating in a broadcaster role 14. For example, the commands might be a “turn to peripheral” or “continue as broadcaster” etc. To effectively communicate, the time that a sensor 10b-10n is switching to and operating in an observer mode and then capable to receive commands would also need to be known by a controller 20 operating as the master or other sensor 10b-10n operating as a broadcaster. The time instance and duration that a sensor 10b-10n is configured to act as observer can be defined by the device itself and communicated to the controller 20 as payload of broadcast packet or defined during commissioning process and programmed to the device. Therefore, a command in the form of broadcast packet from controller 20 (master) can define the role of the sensor 10b-10n and facilitate a change to a peripheral role 16.

In another embodiment, another instance in which a sensor 10b-10n operating in a slave capacity could change functionality would be on application of an external power source 26. In this instance, a sensor 10b-10n is connected to and operating with a battery only as its power source, the sensor 10b-10n shall act as broadcaster role 14 only to minimize power consumption as described above. However, if an external power source 26 is connected, the sensor 10b-10n changes roles and operates in a peripheral role 16. Advantageously this configuration utilizes the advantages of operation in both roles, that is, when power consumption is more important, operating in a broadcaster role 14, however when power consumption concerns are less important because battery life is not impacted when operating with an external power source sensor 10b-10n operates in a peripheral role 16.

In yet another embodiment, yet another instance in which a sensor 10b-10n operating in a slave capacity could change functionality would be on a selected important data exchange. For example, a sensor 10b-10n operating in a broadcaster role 14 when providing conventional data to the master, for example controller 20 in the HVAC system example. However, if and when a sensor 10b-10n determines that more important data needs to be transmitted for which either authentication or secure communications would be warranted, the a sensor 10b-10n changes its function to operate in a peripheral role 16 and thereby connects to controller 20 (master). For example, a sensor 10b-10n could be pre-programmed to change roles based on selected parameters or parameters configured by a master e.g., a change in temperature above 5 degrees in a temperature sensor changes the role to peripheral so the communications can be verified. In addition, the parameter, and thresholds employed can be configured by a master 10a. Once again this can be accomplished by the sensor 10b-10n sending a connectable advertisement to the controller 20; the controller 20 establishes connection to change the sensor 10b-10n to a peripheral role 16. Once the sensor 10b-10n is in the peripheral role 16, it can then transfer the additional data. For example, the environmental data, status and health parameters, and the like. Moreover, the sensor 10b-10n then receives acknowledgement from controller 20 (master). Once the sensor 10b-10n has completed the transmission of the important data, it disconnects from the controller 20 (master) and the sensor 10b-10n returns to the broadcaster role 14. Once again, there are some unique advantages to the use of this connection scheme. First, by switching to a peripheral role 16 for a short duration, a sensor 10b-10n can ensure that the controller 20 (master) is receiving the data. Second, controller 20 operating as a master device has the opportunity to configure parameters of the sensor 10b-10n operating as a peripheral, for example sampling interval, reporting interval, and the like. Once again this would also facilitate managing sensors by permitting the sensor 10b-10n operating in a peripheral role 16 to be configured such in a commissioning process, where sensor 10b-10n might include services, characteristics, diagnostics and the like.

In a further embodiment, another instance in which a sensor 10b-10n operating in a slave capacity could change functionality would be based on a supervisory input or heartbeat. In this embodiment, a sensor 10b-10n operates in a broadcaster role 14, and perhaps has no or minimal data to provide to the controller 20 operating as a master. The sensor 10b-10n sends broadcaster packets periodically to ensure to the controller 20 that sensor 10b-10n is functional and sampling on environmental data but it perhaps has little or nothing to report. For example, a sensor 10b-10n may provide a status signal or any other data that is not expected to change often. However, like the embodiments above, when sensor 10b-10n has some information to report to the controller 20 (master) it sends the connectable advertisement packet as described previously and then changes to operate in a peripheral role 16.

In an embodiment, another instance in which a sensor 10b-10n operating in a slave capacity could change functionality would be based on the case of unique BLE devices 10b-10n that are operating as BLE beacons. For example, Apple iBeacons, Google EddyStone, Alt beacon, and the like. Most BLE beacons are BLE devices 10b-10n operating as slaves, and configured to always operate in a broadcasting role. However, some of the basic parameters that BLE beacons operate under can be modified. In an embodiment, BLE devices 10b-10n include BLE beacons that are sensors 10b-10n that may be configured based on an operation or command from a BLE device operating as a master, such as controller 20. Once again, as in earlier embodiments, a sensor 10b-10n is configured to operate in a broadcaster role 14. Under certain conditions, the sensor 10b-10n may be configured to change operating modes similar as to the embodiments described earlier. Moreover, a BLE beacon may include some parameters that can be modified or configured. For instance, the rate and the transmit power can be changed as well as the Major and Minor values as defined by the Bluetooth protocol. The Major and Minor values are settings which can be used to connect to specific iBeacons, or to work with more than one iBeacon at the same time. For example, in one embodiment, multiple BLE iBeacons that are sensors 10b-10n may be deployed at a venue, with each sharing the same Universally Unique Identifier (UUID) and use the Major and Minor value pairs to segment and distinguish spaces within the venue. For example, the Major values of all the iBeacons in a specific space can be set to the same value and the Minor value can be used to identify a specific iBeacon within the space. In another embodiment, another scheme that may be employed to effectively operate and save power is to reconfigure the sensors 10b-10n when operating as a beacon to transmit at different powers That is, there may be instances where the transmit power of the beacon may be modified based on the needs of the system. For example, depending on the placement of the beacon, it may be advantageous to increase or decrease the transmit power for selected sensors 10b-10n operating as a beacon. As will be appreciated, if the transmission from selected sensors 10b-10n operating as a beacon can be modified to meet the system's needs, the battery life may be extended. Likewise, if transmission can be minimized for selected sensors 10b-10n operating as a beacon, again, power consumption would be reduced and battery life extended.

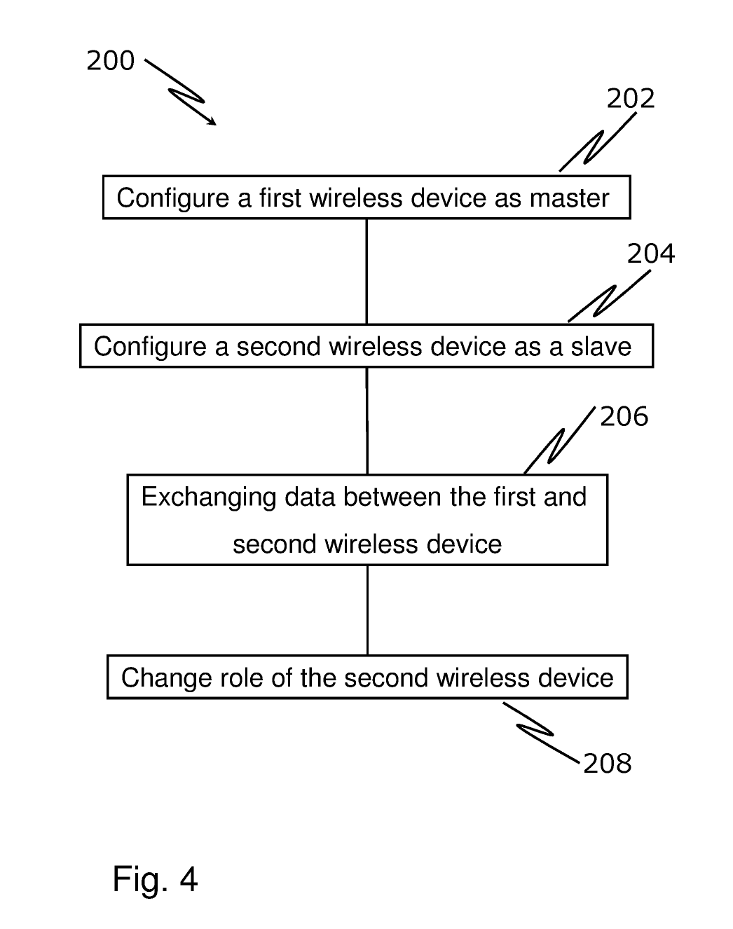

Turning now to FIG. 4 where a flowchart depicting a method shown generally as 200 of conserving power in a wireless network is provided. At process step 202 a first wireless device in a wireless network 100 is configured as a master. At process step 204 a second wireless device is configured as a slave and the two wireless devices communicate and exchange data as depicted at process step 206. In an embodiment, the second wireless device is configured to operate in a broadcaster role 14 as described earlier. Finally at process step 208 the second wireless device changes operating role, for example to a peripheral role 16. Once again, as described in detail with the embodiments previously disclosed, the switch of roles for the wireless devices may be based on one or more of the following conditions: a standard time division or interval; a user triggered event (for example, a button press); on application of some form of external power supply or input; on command from a master; for instances of critical/important data exchange, e.g., for predetermined or selected types of data; based on some form of supervisory input of or heartbeat.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

For example, although shown with various structures, configurations, and modes of operation for the operation of a BLE device operating as a slave to change operating roles, those of skill in the art will appreciate that other, configurations, means of movement, modes of operation etc. may be used without departing from the scope of the present disclosure. Accordingly, the present disclosure is not to be seen as limited by the foregoing description, but is only limited by the scope of the appended claims.

What is claimed is:

1. A method of managing power consumption in a wireless network, the method comprising:
configuring a first wireless device as a master, wherein the master operates in one of a central role and an observer role;
configuring a second wireless device as a slave, wherein the slave operates in one of a first role and a second role, wherein the first wireless device and the second wireless device exchange data over the wireless network; and
changing the second wireless device to operate in the other of the first role and the second role independent of the power supplied to the second wireless device.

2. The method of claim 1 wherein the first role is a broadcaster role and the second role is a peripheral role

3. The method of claim 1, wherein the changing is based on a time division or time interval.

4. The method of claim 3, wherein the time division includes operating in the first role for a first selected duration and operating in the second role for a second selected duration

5. The method of claim 1, wherein the changing is based on a user input.

6. The method of claim 1, wherein the changing is based on application of an external power supply.

7. The method of claim 1, wherein the changing is based on a command from the first wireless device.

8. The method of claim 1, wherein the changing is based on selected types of data to be transmitted from the second wireless device.

9. The method of claim 1, wherein the changing is based on at least one of an important data exchange or a heartbeat function.

10. The method of claim 1, further including configuring a third wireless device as a slave, wherein the third wireless device alternates between the first and second roles with the second wireless device, wherein the first wireless device, the second wireless device and the third wireless device exchange data over the wireless network.

11. The method of claim 1, wherein the first wireless device and the second wireless device are Bluetooth Low Energy devices.

12. A system for managing power consumption in a wireless network, the system comprising:
a first wireless device configured as a master, wherein the master operates in one of a central role and an observer role;
a second wireless device configured as a slave, wherein the slave operates in one of a first role and a second role, wherein the first wireless device and the second wireless device exchange data over the wireless network;
wherein the second wireless device is configured to operate in the other of the first role and the second role under a selected condition independent of the power supplied to the second wireless device.

13. The system of claim 12 wherein the first role is a broadcaster role and the second role is a peripheral role

14. The system of claim 12, wherein the selected condition is based on a time division or a time interval.

15. The system of claim 14, wherein the time division includes operating in the first role for a first selected duration and operating in the second role for a second selected duration

16. The system of claim 12, wherein the selected condition is based on at least one of: a user input; application of an external power supply; a command from the first wireless device; selected types of data to be transmitted from the second wireless device; and a heartbeat function.

17. The system of claim 12, further including a third wireless device configured as a slave, wherein the third wireless device alternates between the first and second roles with the second wireless device, wherein the first wireless device, the second wireless device and the third wireless device exchange data over the wireless network.

18. The system of claim 12, wherein the first wireless device and the second wireless device are Bluetooth Low Energy devices.

19. A heating, ventilation and air conditioning (HVAC) management system configured to control an atmospheric condition of a space comprising:
a plurality of air manipulation components to alter the atmospheric condition of the space;
a controller in operative communication with the plurality of air manipulation components, the controller comprising a first wireless device configured as a master for receiving the at least one parameter from the sensor via a wireless network and operating in one of a central role and observer role,
a sensor disposed proximate to the space for sensing a parameter associated with the space; the sensor operable as a second wireless device configured as a slave operable in one of a first role and a second role,
wherein the sensor is configured to operate in the other of the first role and the second role under a selected condition independent of the power supplied to the second wireless device.

20. The HVAC management system of claim 18, wherein the first wireless device and the second wireless device are Bluetooth Low Energy devices.

21. The HVAC management system of claim 18, wherein the first role is a broadcaster role and the second role is a peripheral role.

22. The HVAC management system of claim 17, wherein the selected condition is based on at least one of: a time division, a user input; application of an external power supply; a command from the first wireless device; selected types of data to be transmitted from the second wireless device; and a heartbeat function.
